(19) United States
(12) Patent Application Publication
(10) Pub. No.: US 2004/0107258 A1
(43) Pub. Date: Jun. 3, 2004

(54) Method and apparatus for managing electronic mail

(75) Inventor: Jae-Ho Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/614,790

(22) Filed: Jul. 9, 2003

(30) Foreign Application Priority Data
Nov. 29, 2002 (KR) 2002-75302

(51) Int. Cl. G06F 15/16

(52) U.S. Cl. 709/206

(57) ABSTRACT

A method and apparatus for managing an electronic mail. An e-mail address is extracted from a received electronic mail, and then the extracted e-mail address is stored. An electronic mail is sent using the stored e-mail address. Accordingly, unlike an existing method of generating an e-mail address of a receiver, who will receive an e-mail, by using external input keys, an e-mail address of a receiver can be found from previously stored e-mail addresses. Thus, it is not necessary to include many external input keys. Also, the inconvenience a user may experience when manipulating external input keys to generate an e-mail address of a receiver can be minimized.

### CROSS-REFERENCE TO RELATED APPLICATIONS

This application claims the priority of Korean Patent Application No. 2002-75302, filed Nov. 29, 2002, in the Korean Intellectual Property Office, the disclosure of which is incorporated herein in its entirety by reference.

### BACKGROUND OF THE INVENTION

1. Field of the Invention

The present invention relates to electronic mail, and more particularly, to a method and apparatus for managing electronic mail by managing and using an electronic mail address of a receiver.

2. Description of the Related Art

Hereinafter, a method of managing electronic mail (e-mail) according to the related art will be described.

In a typical configuration, a plurality of personal computers (not shown) share a multi-function peripheral (not shown). Here, a user creates an e-mail in his or her personal computer, supplies the e-mail to a multi-function peripheral, and sends the e-mail to a receiver using the multi-function peripheral. The user creates an e-mail address of a receiver by manipulating external input keys (not shown) of the multi-function peripheral. One external input key can represent one of the codes that the e-mail address of a receiver shows.

Accordingly, if the method of managing an e-mail according to the related art is used, the number of external input keys representing all of the codes for the e-mail addresses of the receivers exist in a multi-function peripheral. Thus, the multi-function peripheral requires many external input keys to indicate an e-mail address of a receiver. In addition, an operation of selecting external input keys that make up the e-mail address of the receiver has to be repeated several times in order to create the e-mail address of the receiver. Thus, in the method of managing an e-mail according to the related art, the operations taken by the user can be complicated and/or time-consuming since the user must manipulate external input keys to create an e-mail address of a receiver.

### SUMMARY OF THE INVENTION

Accordingly, the present invention provides a method of managing an e-mail by which an e-mail address of a receiver who will receive an e-mail can be obtained easily and conveniently when sending an e-mail.

The present invention also provides an apparatus managing an e-mail in which an e-mail address of a receiver, who will receive an e-mail, can be obtained easily and conveniently when sending an e-mail.

According to an aspect of the present invention, in a method of managing electronic mail, an e-mail address is extracted from a received electronic mail, and then the extracted e-mail address is stored. An electronic mail is sent using the stored e-mail address.

According to another aspect of the present invention, an apparatus managing electronic mail includes an e-mail address manager and a transmission manager. The e-mail address manager extracts an e-mail address from a received electronic mail and stores the extracted e-mail address. The transmission manager sends an electronic mail using the e-mail address stored in the e-mail address manager.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a flowchart explaining a method of managing an e-mail according to an embodiment of the present invention;

FIG. 2 is a flowchart explaining operation 5 shown in FIG. 1;

FIG. 3 is a flowchart explaining operation 7 shown in FIG. 1;

FIG. 4 is a block diagram of an apparatus managing an e-mail according to an embodiment of the present invention;

FIG. 5 is a block diagram of an e-mail address manager of the apparatus shown in FIG. 4; and

FIG. 6 is a block diagram of a transmission manager of the apparatus shown in FIG. 4.

### DETAILED DESCRIPTION OF THE PREFERRED EMBODIMENTS

Hereinafter, a method of managing an e-mail according to embodiments of the present invention will be described in detail with reference to the attached drawings, wherein like reference numerals indicate like elements.

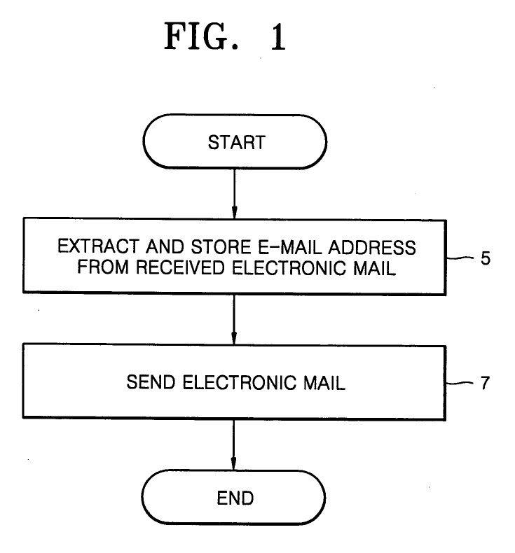

FIG. 1 is a flowchart explaining a method of managing an e-mail according to an embodiment of the present invention. Here, the method comprises operations 5 and 7 of automatically storing an e-mail address included in a received e-mail and then sending an e-mail using the stored e-mail address. In the method of managing an e-mail, an e-mail address included in a received e-mail is extracted and stored in operation 5.

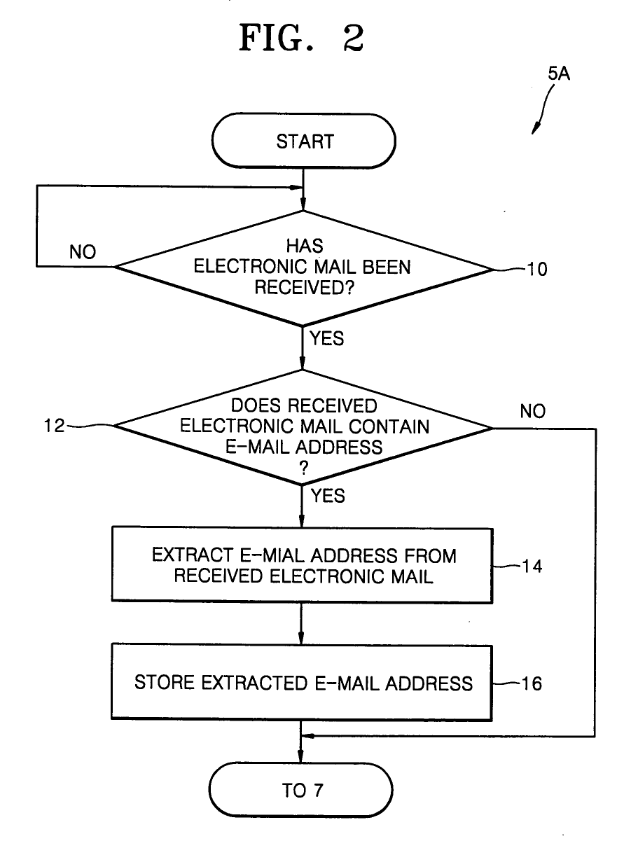

FIG. 2 is a flowchart explaining an embodiment 5A of the present invention for operation 5 shown in FIG. 1. The embodiment 5A includes operations 10, 12, 14, and 16 of extracting and storing an e-mail address contained in a received e-mail. operation 10, determines whether an e-mail is received. If the e-mail has not been received, the process goes back to operation 10. However, if the e-mail has been received, in operation 12, determines whether an e-mail address is included in the received e-mail. If the e-mail address is included in the received e-mail, the e-mail address is extracted from the e-mail in operation 14.

Referring to FIG. 2, in the method of managing an e-mail according to an embodiment of the present invention, operation 10, determines whether an e-mail is received. If the e-mail has not been received, the process goes back to operation 10. However, if the e-mail has been received, operation 12, determines whether an e-mail address is included in the received e-mail. If the e-mail address is included in the received e-mail, the e-mail address is extracted from the e-mail in operation 14.

According to an embodiment of the present invention, the e-mail managing method shown in FIG. 1 may be performed by a personal computer (not shown). In this case, an e-mail address included in an e-mail, which is created in and sent from another personal computer (not shown), may exist in a header of the received e-mail.

According to another embodiment of the present invention, the e-mail managing method shown in FIG. 1 may be carried out in a multi-function peripheral (not shown), which is connected to at least one personal computer. In this case, if an e-mail address is included in an e-mail, which is created in a personal computer of a user, sent to a multi-function peripheral, and then received in the multi-function peripheral, the e-mail address is extracted from the text of the received e-mail.

For example, if an e-mail is received, operation 12 determines whether the received e-mail has a sign or symbol, e.g., @, expressing an e-mail address. If the sign expressing the e-mail address exists in the received e-mail, in operation 14, the e-mail address having the sign is extracted. After operation 14, the e-mail address extracted from the e-mail is stored in operation 16, and the process goes to operation 7. After operation 5, an e-mail is sent using the stored e-mail address in operation 7.

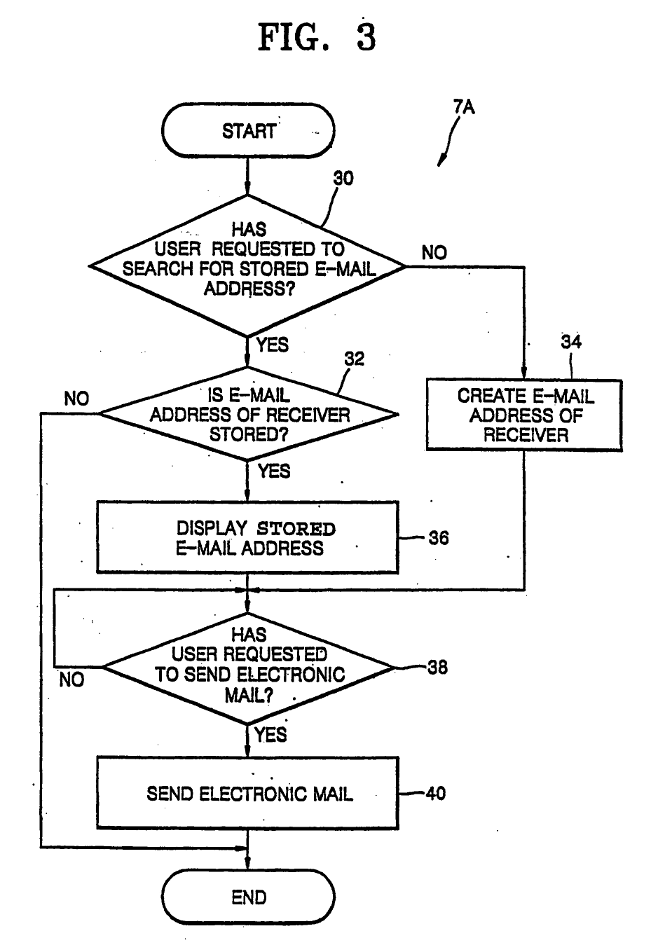

FIG. 3 is a flowchart explaining an embodiment 7A of the present invention of operation 7 shown in FIG. 1. The embodiment 7A includes operations 30, 32, 34, 36, 38, and 40 of sending an e-mail using a stored e-mail address. After operation 5, operation 30 determines whether a user requests to search for a stored e-mail address. If the user requests to search for the stored e-mail address, operation 32 determines whether an e-mail address of a receiver who will receive an e-mail is stored.

However, if the user does not request to search for the stored e-mail address, in operation 34, an e-mail address of a receiver is created. For example, if the e-mail managing method shown in FIG. 1 is performed in a personal computer, the user creates an e-mail address of a receiver using a keyboard (not shown) connected to the personal computer when the user does not request to search for the stored e-mail address. However, if the e-mail managing method shown in FIG. 1 is performed in a multi-function peripheral, the user may create an e-mail address of the receiver by manipulating external input keys (not shown) prepared in the multi-function peripheral when the user does not request to search for the stored e-mail address.

According to another embodiment of the present invention, in contrast to the FIG. 3 operation 32 flow, if operation 32 determines that an e-mail address of the receiver is not stored, at operation 34, the e-mail address of the receiver is created. That is, when at operation 32 the e-mail address of the receiver is not stored, the email address of the receiver is created in operation 34, instead of ending the method as shown in FIG. 3.

As described above, when a user desires to send an e-mail, the user may search for an e-mail address of a receiver who will receive the e-mail, among the e-mail addresses stored in operation 5 or create a new e-mail address.

According to an embodiment of the present invention, if an e-mail address of a receiver is stored, the stored e-mail address is displayed to a user in operation 36. After operation 34 or 36, operation 38 determines whether the user requests to send an e-mail.

According to another embodiment of the present invention, operation 7A shown in FIG. 3 may not include operation 36. In this case, if an e-mail address of a receiver is stored or after operation 34, operation 38 determines whether a user requests to send an e-mail.

If the user does not request to send the e-mail, the process repeats operation 38. However, if the user requests to send the e-mail, in operation 40, the e-mail is sent to a stored or created e-mail address of the receiver.

Hereinafter, an embodiment of the structure and operation of an e-mail managing apparatus of the present invention performing the above-described e-mail managing method will be described with reference to the attached drawings.

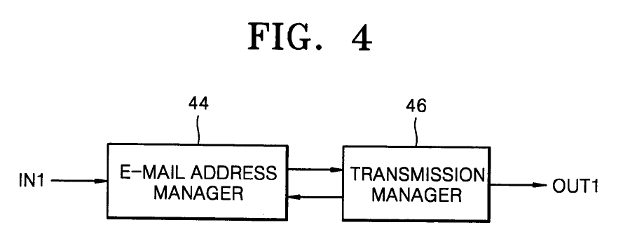

FIG. 4 is a block diagram of an apparatus managing an e-mail according to an embodiment of the present invention. The apparatus includes an e-mail address manager 44 and a transmission manager 46.

The apparatus shown in FIG. 4 serves to carry out the e-mail managing method shown in FIG. 1. For example, the e-mail address manager 44 extracts and stores an e-mail address included in an e-mail received via an input port IN1 to perform operation 5 shown in FIG. 1.

According to an embodiment of the present invention, the apparatus shown in FIG. 4 may be a personal computer. In this case, the e-mail address manager 44 of the personal computer inputs an e-mail from the personal computer.

According to another embodiment of the present invention, the apparatus shown in FIG. 4 may be a multi-function peripheral connected to at least one personal computer. In this case, the e-mail address manager 44 of the multi-function peripheral inputs an e-mail from the personal computer. Here, when an e-mail is created in the personal computer, a user writes an e-mail address of a receiver who will receive the e-mail in the text of the e-mail. Thus, the e-mail address manager 44 may receive an e-mail created in a personal computer via the input port IN1, extract an e-mail address of a receiver from the text of the received e-mail, and store the extracted e-mail address of the receiver.

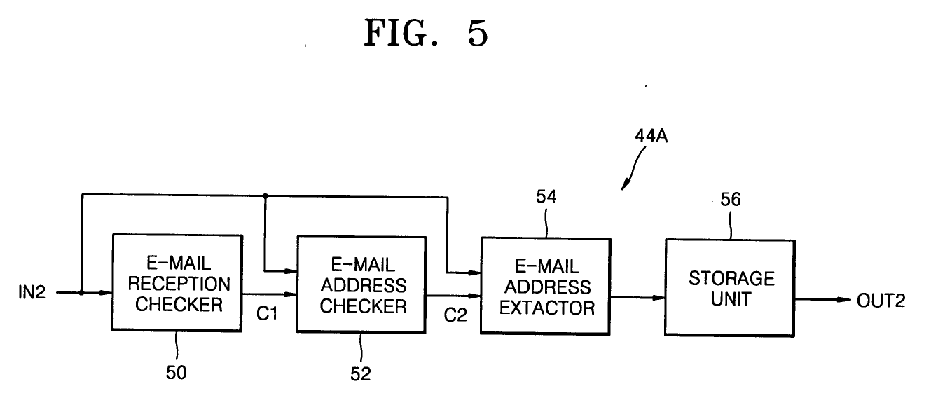

FIG. 5 is a block diagram of an embodiment 44A of the present invention of the e-mail address manager 44. The e-mail address manager 44A includes an e-mail reception checker 50, an e-mail address checker 52, an e-mail address extractor 54, and a storage unit 56.

The e-mail address manager 44A shown in FIG. 5 serves to perform operation 5A shown in FIG. 2. For example, the e-mail reception checker 50 of the e-mail address manager 44A checks whether an e-mail is received via an input port IN2 and outputs the checked result as a first control signal Cl to the e-mail address checker 52 in order to carry out operation 10 shown in FIG. 2.

In order to perform operation 12, the e-mail address checker 52 checks whether an e-mail received via the input port IN2 contains an e-mail address and outputs the checked result as a second control signal C2 to the e-mail address extractor 54 in response to the first control signal C1 input from the e-mail reception checker 50. For example, if the e-mail address checker 52 perceives through the first control signal C1 that the e-mail has been received, the e-mail address checker 52 checks whether the received e-mail contains an e-mail address. For this, the e-mail address checker 52 checks whether the e-mail received via the input port IN2 has a sign, e.g., @, indicative of an e-mail address and outputs the checked result as the second control signal C2 to the e-mail address extractor 54.

In order to carry out operation 14, the e-mail address extractor 54 extracts the e-mail address from the e-mail received via the input port IN2 and outputs the extracted e-mail address to the storage unit 56 in response to the second control signal C2 input from the e-mail address checker 52. For example, if the e-mail address extractor 54 perceives through the second control signal C2 that the received e-mail contains the e-mail address, the e-mail address extractor 54 extracts the e-mail address from the e-mail received from the input port IN2.

To perform operation 16, the storage unit 56 stores the extracted e-mail address input from the e-mail address extractor 54 and outputs the stored e-mail address via an output port OUT2.

To carry out operation 7 shown in FIG. 1, the transmission manager 46 sends an e-mail via an output port OUT1 using the e-mail address stored in the e-mail address manager 44.

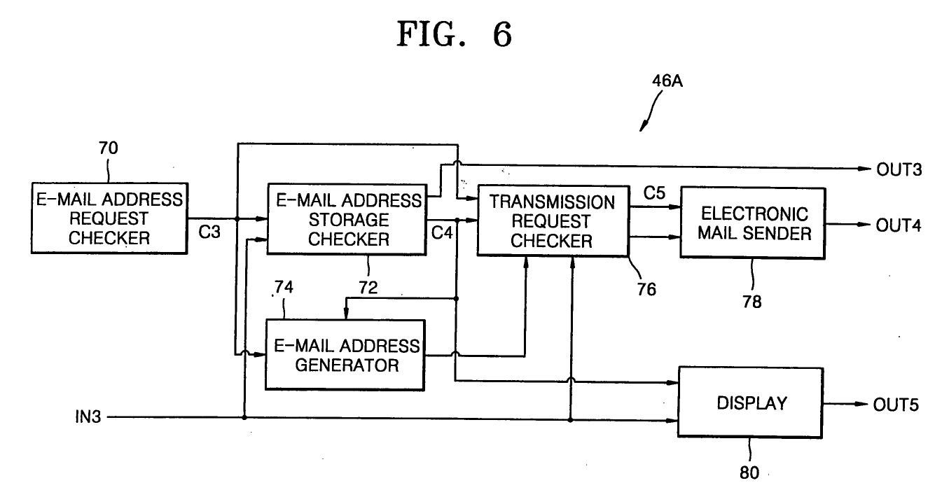

FIG. 6 is a block diagram of an embodiment 46A of the present invention of the transmission manager 46 shown in FIG. 4. The transmission manager 46A includes an e-mail address request checker 70, an e-mail address storage checker 72, an e-mail address generator 74, a transmission request checker 76, an e-mail sender 78, and a display 80.

The transmission manager 46A shown in FIG. 6 serves to perform operation 7A shown in FIG. 3. For example, in order to perform operation 30, the e-mail address request checker 70 of the transmission manager 46A checks whether a request to search for an e-mail address stored in the storage unit 56 has been made and outputs the checked result as a third control signal C3 to the e-mail address storage checker 72, the e-mail address generator 74, and the transmission request checker 76. For this, the e-mail address request checker 70 may be in the form of a search key (not shown) or the like. Here, the search key is manipulated by a user, who requests to search for the e-mail address stored in the storage unit 56, so as to generate the third control signal C3.

To perform operation 32, the e-mail address storage checker 72 checks in response to the third control signal C3 input from the e-mail address request checker 70 whether the storage unit 56 stores an e-mail address of a receiver, who will receive an e-mail to be sent, and outputs the checked result as a fourth control signal C4 to the transmission request checker 76 and the display 80. For example, if the e-mail address storage checker 72 perceives through the third control signal C3 that a request to search for the stored e-mail address has been made, the e-mail address storage checker 72 outputs through the output port OUT3 to the storage unit 46 a reading request signal requesting to read out the e-mail address stored in the storage unit 56. Here, the storage unit 56 outputs an e-mail address (addresses) stored therein to the e-mail address storage checker 72 in response to the reading request signal input form the e-mail address storage checker 72. Thus, the e-mail address storage checker 72 searches for stored e-mail addresses input from the storage unit 56 via an input port IN3 to find an e-mail address of a receiver.

To perform operation 34, the e-mail address generator 74 generates an e-mail address of a receiver and outputs the generated e-mail address of the receiver to the transmission request checker 76 in response to the third control signal C3 input from the e-mail address request checker 70. For example, if the e-mail address generator 74 perceives through the third control signal C3 that a search for stored e-mail addresses is not requested, the e-mail address generator 74 generates the e-mail address of the receiver.

According to another embodiment of the present invention, the e-mail address generator 74 can generate the e-mail address, if the e-mail address generator 74 perceives through the fourth control signal C4 output from the e-mail address storage checker 72 that the e-mail address of the receiver is not stored. Accordingly, the e-mail address generator 74 generates an e-mail address of a receiver, if a search for stored e-mail address is not requested according to the control signal C3. Further, the e-mail address generator 74 generates an e-mail address of a receiver, if the e-mail address of the receiver is not found by the e-mail address storage checker 72 according to the control signal C4. The e-mail address generator 74 may be in form of keyboard input.

To carry out operation 38, the transmission request checker 76 passes to the e-mail sender 78 one of the e-mail addresses generated by the e-mail address generator 74 and the stored e-mail address input from the storage unit 56 via the input port IN3, in response to the third and fourth control signals C3 and C4 output from the e-mail address request checker 70 and the e-mail address storage checker 72, respectively. Also, the transmission request checker 76 checks whether the delivery of an e-mail has been requested and outputs the checked result as a fifth control signal C5 to the e-mail sender 78. For example, if the transmission request checker 76 perceives through the third control signal C3 that a search for a stored e-mail address has been requested and through the fourth control signal C4 that an e-mail address of a receiver is stored, the transmission request checker 76 passes to the e-mail sender 78 the stored e-mail address input from the storage unit 56 via the input port IN3. Also, if the transmission request checker 76 perceives through the third control signal C3 that a search for the stored e-mail address has not been requested, the transmission request checker 76 passes the address generated by the e-mail address generator 74 to the e-mail sender 78.

To carry out operation 40, the e-mail sender 78 sends an e-mail to the e-mail address of the receiver passed from the transmission request checker 76 via an output port OUT4 in response to the fifth control signal C5 input from the transmission request checker 76. For example, if the e-mail sender 78 perceives through the fifth control signal C5 that the delivery of an e-mail has been requested, the e-mail sender 78 sends an e-mail to the e-mail address of the receiver passed from the transmission request checker 76.

According to an embodiment of the present invention, the transmission manager 46A shown in FIG. 6 may further include the display 80 in order to perform operation 36 of FIG. 3. Here, the display 80 displays through the output port OUT5 to the user the stored e-mail address input via the input port IN3 in response to the fourth control signal C4 input from the e-mail address storage checker 72. For example, if the display 80 perceives through the fourth control signal C4 that the e-mail address of the receiver is stored in the storage unit 56, the display 80 displays the e-mail address input from the storage unit 56 via the input port IN3.

As described above, unlike a conventional method of generating an e-mail address of a receiver who will receive an e-mail by using external input keys, in a method and apparatus for managing an e-mail according to the present invention, an e-mail address of a receiver can be found from previously stored e-mail addresses. Thus, it is not necessary to include many external input keys. Also, the inconvenience a user may experience when manipulating external input keys to generate an e-mail address of a receiver can be minimized.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of managing an electronic mail, the method comprising:
extracting an e-mail address from a received electronic mail;
storing the extracted e-mail address; and
sending an electronic mail using the stored e-mail address.

2. The method of claim 1, wherein the extracting the e-mail address comprises:
determining whether the electronic mail has been received;
if determined that the electronic mail has been received, determining whether the received electronic mail includes the e-mail address; and
if determined that the received electronic mail includes the e-mail address, extracting the included e-mail address;
wherein electronic mail is sent using the stored e-mail address.

3. The method of claim 1, wherein the extracting the e-mail address comprises extracting the e-mail address written in text of the received electronic mail.

4. The method of claim 2, wherein, if determined that the electronic mail has been received, then the determining whether the received electronic mail includes the e-mail address comprises determining whether the received electronic mail has a sign indicating the e-mail address, and, if determined that the received electronic mail has the sign, then the extracting the included e-mail address comprises extracting the e-mail address having the sign.

5. The method of claim 1, wherein the sending the electronic mail using the stored e-mail address comprises:
determining whether a search for the stored e-mail address has been requested;
if determined that the search for the stored e-mail address has been requested, determining whether an e-mail address of a receiver who receives an electronic mail to be sent is stored;
if determined that the search for the stored e-mail address has not been requested, generating the e-mail address of the receiver;
if determined that the e-mail address of the receiver is stored or after the generating the e-mail address of the receiver, determining whether the transmission of the electronic mail has been requested; and
if determined that the delivery of the electronic mail has been requested, sending the electronic mail to the stored e-mail address of the receiver or the generated e-mail address of the receiver.

6. The method of claim 5, wherein the sending the electronic mail using the stored e-mail address further comprises:
if determined that the e-mail address of the receiver is stored, displaying the stored e-mail address and going to the determining whether the transmission of the electronic mail has been requested;
wherein the determining whether the transmission of the electronic mail has been requested comprises determining whether the delivery of the electronic mail has been requested after the the generating the e-mail address of the receiver or the displaying the stored e-mail address.

7. An apparatus managing an electronic mail, the apparatus comprising:
an e-mail address manager that extracts an e-mail address from a received electronic mail and stores the extracted e-mail address; and
a transmission manager that sends an electronic mail using the e-mail address stored in the e-mail address manager.

8. The apparatus of claim 7, wherein the e-mail address manager comprises:
an electronic mail reception checker that checks whether an electronic mail is received and outputs the checked result as a first control signal;
an e-mail address checker that checks whether the received electronic mail includes an e-mail address and outputs the checked result as a second control signal in response to the first control signal;
an e-mail address extractor that extracts the e-mail address from the received electronic mail in response to the second control signal; and
a storage unit that stores the extracted e-mail address input from the e-mail address extractor.

9. The apparatus of claim 8, wherein the apparatus comprises a personal computer.

10. The apparatus of claim 8, wherein the apparatus comprises a multi-function peripheral connected to at least one personal computer.

11. The apparatus of claim 10, wherein the e-mail address manager extracts the e-mail address from text of the received electronic mail generated in the personal computer.

12. The apparatus of claim 8, wherein the e-mail address checker checks whether the received electronic mail has a sign indicating an e-mail address and outputs the checked result as the second control signal.

13. The apparatus of claim 10, wherein the transmission manager comprises:
an e-mail address request checker that checks whether a search for the e-mail address stored in the storage unit has been requested and outputs the checked result as a third control signal;
an e-mail address storage checker that checks whether an e-mail address of a receiver, who receives an electronic mail to be sent, is stored in the storage unit and outputs the checked result as a fourth control signal in response to the third control signal;
an e-mail address generator that generates the e-mail address of the receiver and outputs the generated e-mail address of the receiver in response to the third control signal;
a transmission request checker that passes the generated e-mail address or the stored e-mail address, checks whether the delivery of the electronic mail is requested, and outputs the checked result as a fifth control signal in response to the third and fourth control signals; and
an electronic mail sender that sends the electronic mail to the e-mail address of the receiver, which has been passed by the transmission request checker, in response to the fifth control signal.

14. The apparatus of claim 13, wherein the transmission manager further comprises a display that displays the stored e-mail address in response to the fourth control signal.

15. A method of managing an electronic message, comprising:
receiving a first electronic message;
extracting a sender address from the received first electronic message;
storing the extracted sender address; and
sending a second electronic message using the stored sender address.

16. A method of managing electronic mail, comprising:
determining whether a received electronic mail includes an e-mail address;
extracting the e-mail address from the received electronic mail; and
storing the extracted e-mail address.

17. The method of claim 16, wherein the determining whether the received electronic mail includes the e-mail address includes determining whether the received electronic message includes a symbol indicative of the e-mail address.

18. The method of claim 17, wherein the symbol comprises @ such that the determining includes determining whether the @ symbol is included in the electronic message.

19. The method of claim 16, wherein the received electronic mail comprises a message header and a message body and the extracting the e-mail address from the received electronic message includes extracting the e-mail address from the message body.

20. The method of claim 16, further comprising:
sending a subsequent electronic message to a message recipient.

21. The method of claim 20, further comprising:
searching a memory for the e-mail address of the message recipient;
wherein the sending comprises sending the subsequent electronic message to the message recipient at the stored e-mail address if the stored e-mail address is located in the memory.

22. The method of claim 21, further comprising:
generating the e-mail address of the message recipient if the e-mail address is not in the memory.

23. The method of claim 16, wherein the received electronic mail comprises a message header and a message body and the extracting the e-mail address from the received electronic message includes extracting the e-mail address from the message header.

24. The method of claim 22, further comprising:
displaying the e-mail address of the message recipient.

25. The method of claim 20, further comprising:
determining whether a message sender requests to send the subsequent electronic message to the message recipient; and
wherein the sending comprises sending the subsequent electronic message to the message recipient if the sender desires to send the subsequent electronic message to the message recipient.

26. An e-mail address manager, comprising:
an e-mail reception checker that checks whether an e-mail is received via an input port IN2 and outputs the checked result as a first control signal;
an e-mail address checker that receives the first control signal to check whether the e-mail contains an e-mail address and outputs a checked result as a second control signal;
an e-mail address extractor that extracts the e-mail address from the checked result in the second control signal and outputs the extracted e-mail address; and
a storage unit that stores the extracted e-mail address.

27. The e-mail address manager of claim 26, wherein the e-mail address checker checks whether the received e-mail includes a symbol indicative of an e-mail address.

28. The e-mail address manager of claim 26, wherein the storage unit comprises an output unit that outputs the extracted e-mail address.

29. An e-mail transmission manager, comprising:
an e-mail address request checker that outputs a search request in a third control signal if a request for a stored e-mail address is detected;
an e-mail address storage checker that searches a storage unit for the e-mail address if the third control signal contains the search request and outputs the e-mail address in a fourth control signal if the e-mail address is located in the storage unit;
an e-mail address generator that generates an e-mail address if there is not a search request in the third control signal and no stored e-mail address in the fourth control signal; and
a transmission request checker that outputs the stored e-mail address or the generated e-mail address in a fifth control signal.

30. The e-mail transmission manager of claim 29, further comprising an e-mail sender that sends an e-mail to a receiver at the stored e-mail address or the generated e-mail address in the fifth control signal.

31. The e-mail transmission manager of claim 30, further comprising:
a display that displays the stored e-mail address in the fourth control signal.
